(19) United States
(12) Patent Application Publication
(10) Pub. No.: US 2015/0099828 A1
(43) Pub. Date: Apr. 9, 2015

(54) LAMINATE AND METHOD FOR PRODUCING SAME

(71) Applicant: MITSUBISHI RAYON CO., LTD., Tokyo (JP)

(72) Inventors: Miki Akimoto, Yokohama-shi (JP); Hideaki Kuwano, Yokohama-shi (JP)

(73) Assignee: Mitsubishi Rayon Co., Ltd., Tokyo (JP)

(21) Appl. No.: 14/396,825

(22) PCT Filed: Apr. 24, 2013
(86) PCT No.: PCT/JP2013/062035

§ 371 Date: Oct. 24, 2014

(30) Foreign Application Priority Data
Apr. 25, 2012 (JP) 2012-099783

(51) Int. Cl. C09D 133/12; C09D 175/04; B05D 3/06

(52) U.S. Cl. CPC C09D 133/12; B05D 3/067; C09D 175/04
USPC 523/400; 427/558; 524/590

(57) ABSTRACT

A laminate which has a cured layer formed on a base and made from a curable composition containing (A) a heat- and/or ultraviolet ray-curable resin and (B) inorganic microparticles having a functional group capable of binding to the component (A), in which the absorbance ratio P_{C═O}/P_{Si—O} of the peak absorbance P_{C═O} around a wavelength of 1,730 cm⁻¹ to the peak absorbance P_{Si—O} around a wavelength of 1,100 cm⁻¹ falls within the range from 0.15 to 0.35 as measured by a single reflection ATR method using an infrared spectrophotometer.

### TECHNICAL FIELD

The present invention relates to a laminate with excellent abrasion resistance, scratch resistance, transparency, and adhesiveness to a base, and a method for producing the laminate.

### BACKGROUND ART

Recently, a transparent plastic material having excellent anti-friability and lightness such as an acrylic resin and a polycarbonate resin is widely used as a substitute for a transparent glass. However, as having lower surface hardness compared to glasses, the transparent plastic material has a problem of easily having a scratch on the surface thereof.

Accordingly, many attempts have been conventionally made to improve the scratch resistance of a plastic material. For example, a method has been suggested in which an inorganic-based polymer having a siloxane bond on a base surface is formed by utilizing hydrolysis of an alkoxysilane compound and a subsequent condensation reaction and only the light-exposed sections are modified to a hard thin film having silicon dioxide as a main component by irradiation of excimer light (Patent Document 1). However, the inorganic-based polymer composition having a siloxane bond generally has a problem that it is expensive and has poor storage stability.

Further, a laminate having an acrylic resin layer formed by a vacuum ultraviolet ray curing is suggested (Patent Document 2). However, the laminate described in this patent document has a problem of poor abrasion resistance.

### CITATION LIST

### Patent Document

Patent Document 1: WO 2009/110152 A

Patent Document 2: JP 10-278167 A

### DISCLOSURE OF THE INVENTION

### Problem to be Solved by the Invention

An object of the present invention is to provide a laminate with excellent abrasion resistance, scratch resistance, transparency, and adhesiveness to a base, and a method for producing the laminate. It is also to provide a laminate in which an inexpensive coating material with excellent storage stability is used.

### Means for Solving Problem

As a result of conducting intensive studies to solve the aforementioned problems, inventors of the present invention found that a laminate with excellent abrasion resistance, scratch resistance, transparency, and adhesiveness to a base can be obtained when a coating film of a curable composition containing (A) a heat- and/or ultraviolet ray-curable resin and (B) inorganic microparticles having a functional group capable of binding to the component (A) is formed on a base, the coating film is cured by using heat and/or ultraviolet ray to form a cured layer, and vacuum ultraviolet ray is irradiated on a surface of the cured layer. The present invention is completed accordingly.

In other words, the aspects of the present invention are as described below.

(1) A laminate having a cured layer formed on a base and made from a curable composition containing (A) a heat- and/or ultraviolet ray-curable resin and (B) inorganic microparticles having a functional group capable of binding to the component (A), in which the around a wavelength of 1,730 cm⁻¹ to the peak absorbance P_{Si—O} around a wavelength of 1,100 cm⁻¹ falls within the range from 0.15 to 0.35 as measured by a single reflection ATR method using an infrared spectrophotometer.

(2) The laminate described in (1), in which the content of the component (B) is 15 to 40 parts by mass in 100 parts by mass of total of the component (A) and the component (B).

(3) The laminate described in (1) or (2), in which a change in haze value ΔH before and after the Taber abrasion test prescribed by ISO 9352 (JIS K-7204) (test condition: abrasion wheel of CS-10F, load of 500 g, and 500 revolutions) is 10% or less.

(4) A method for producing a laminate including:

a step of forming a cured layer by forming on a base a coating film of a curable composition containing (A) a heat- and/or ultraviolet ray-curable resin and (B) inorganic microparticles having a functional group capable of binding to the component (A) and curing the coating film by using heat and/or ultraviolet ray, and a step of irradiating vacuum ultraviolet ray on a surface of the cured layer.

(5) The production method described in (4), in which the irradiation of vacuum ultraviolet ray is performed by using an excimer lamp.

### Effect of the Invention

According to the aspects of the present invention, a laminate with excellent abrasion resistance, scratch resistance, transparency, and adhesiveness to a base and a method for producing the laminate can be provided.

### MODE(S) FOR CARRYING OUT THE INVENTION

### Laminate

In the present invention, the laminate has a cured layer (cured coating film) of a curable composition described below which contains (A) a heat- and/or ultraviolet ray-curable resin and (B) inorganic microparticles having a functional group capable of binding to the component (A), in which the absorbance ratio P_{C═O}/P_{Si—O} of the peak absorbance P_{C═O} around a wavelength of 1,730 cm⁻¹ to the peak absorbance P_{Si—O} around a wavelength of 1,100 cm⁻¹ falls within the range from 0.15 to 0.35 as measured by a single reflection ATR method using an infrared spectrophotometer.

<Heat- and/or Ultraviolet Ray-Curable Resin (A)>

Descriptions are given for the heat- and/or ultraviolet ray-curable resin (A) according to an embodiment of the present invention.

Examples of the heat-curable resin include an unsaturated polyester resin.

Examples of the ultraviolet ray-curable resin (A) include an acrylic resin.

Hereinbelow, the acrylic resin is described in detail.

(a) Ethylenically unsaturated compound having radical polymerizable functional group

The component (a) is a component to provide a cured coating film to be obtained with hardness. Specific examples thereof include dipentaerythritol hexa(meth)acrylate, hexa(meth)acrylate of an adduct of dipentaerythritol and ε-caprolactone, hexa(meth)acrylate, dipentaerythritol monohydroxypenta(meth)acrylate, alkyl-modified dipentaerythritol penta(meth)acrylate, alkyl-modified dipentaerythritol tetra(meth)acrylate, pentaerythritol tri(meth)acrylate, pentaerythritol tetra(meth)acrylate, trimethylol propane tri(meth)acrylate, tris(2-acryloyloxyethyl)isocyanurate, neopentyl glycol di(meth)acrylate, ethylene glycol di(meth)acrylate, propylene glycol di(meth)acrylate, butylene glycol di(meth)acrylate, hexane diol di(meth)acrylate, nonane diol di(meth)acrylate, dicyclopentanyl di(meth)acrylate, polyethylene glycol di(meth)acrylate, polypropylene glycol di(meth)acrylate, epoxypoly(meth)acrylate such as epoxydi(meth)acrylate in which bisphenol A type diepoxy is reacted with (meth)acrylic acid, urethane tri(meth)acrylate in which a trimer of 1,6-hexamethylene diisocyanate is reacted with 2-hydroxyethyl (meth)acrylate, urethane tri(meth)acrylate in which a trimer of 1,6-hexamethylene diisocyanate is reacted with 2-hydroxybutyl (meth)acrylate, urethane di(meth)acrylate in which isophorone diisocyanate is reacted with 2-hydroxypropyl (meth)acrylate, urethane hexa(meth)acrylate in which isophorone diisocyanate is reacted with pentaerythritol tri(meth)acrylate, urethane di(meth)acrylate in which dicyclomethane diisocyanate is reacted with 2-hydroxyethyl (meth)acrylate, urethane poly(meth)acrylate such as urethane di(meth)acrylate in which 2-hydroxyethyl (meth)acrylate is reacted with a urethane reaction product of dicyclomethane diisocyanate and poly (n=6 to 15) tetramethylene glycol, polyester (meth)acrylate in which trimethylol ethane, succinic acid, and (meth)acrylic acid are reacted, polyester poly(meth)acrylate such as polyester (meth)acrylate in which trimethylol propane, succinic acid, ethylene glycol, and (meth)acrylic acid are reacted, 2-hydroxyethyl (meth)acrylic acid ester, 2-hydroxypropyl (meth)acrylic acid ester, 2-hydroxybutyl (meth)acrylic acid ester, 3-hydroxybutyl (meth)acrylic acid ester, 4-hydroxybutyl (meth)acrylic acid ester, 3-chloro-2-hydroxypropyl (meth)acrylic acid ester, 2-hydroxy-3-phenoxypropyl (meth)acrylic acid ester, 2-hydroxypentyl (meth)acrylic acid ester, 4-hydroxypentyl (meth)acrylic acid ester, ethylene oxide or propylene oxide adduct of 2-hydroxyethyl (meth)acrylic acid ester or 2-hydroxypropyl (meth)acrylic acid ester, tetrahydrofurfuryl (meth)acrylic acid, phenyloxyethyl (meth)acrylate, phenoxydiethylene glycol (meth)acrylate, ethylene oxide-modified cresol (meth)acrylate, cyclohexyloxyethyl (meth)acrylate, benzyloxyethyl (meth)acrylate, benzyl (meth)acrylic acid, isobornyloxyethyl (meth)acrylate, norbornyloxyethyl (meth)acrylate, norbornyl (meth)acrylic acid, adamantyl (meth)acrylic acid, dicyclopentenyl (meth)acrylic acid, dicyclopentanyl (meth)acrylic acid, tetracyclododecanyl (meth)acrylic acid, 4-t-butylcyclohexyl (meth)acrylic acid ester, trimethylol propaneformal (meth)acrylate, 2-ethyl-2-methyl-1,3-dioxolan-4-yl-methylacrylate, 2-isobutyl-2-methyl-1,3-dioxolan-4-yl-methylacrylate, ethylene oxide-modified phosphoric acid (meth)acrylate, caprolactone-modified phosphoric acid (meth)acrylate, and mono(meth)acrylic acid ester of an ε-caprolactone adduct of hydroxypyvalic acid neopentyl glycol (n+m=2 to 5).

From the viewpoint of the photopolymerization property of a curable composition or the abrasion property of a cured coating film, in particular, it is preferable to use acrylate with functionality of 2 or higher. Specifically, dipentaerythritol hexaacrylate, hexa(meth)acrylate of an adduct of dipentaerythritol and ε-caprolactone, dipentaerythritol monohydroxypenta(meth)acrylate, alkyl-modified dipentaerythritol penta(meth)acrylate, alkyl-modified dipentaerythritol tetra(meth)acrylate, pentaerythritol tri(meth)acrylate, pentaerythritol tetra(meth)acrylate, trimethylol propane tri(meth)acrylate, and tris(2-acryloyloxyethyl)isocyanurate are preferable.

The ethylenically unsaturated compound (a) having a radical polymerizable functional group may be used either singly or in combination of two or more types.

It is also possible that the ethylenically unsaturated compound (a) having a radical polymerizable functional group is an isocyanate compound, or urethane(meth)acrylate, epoxy(meth)acrylate, or the like which is synthesized from polyhydric alcohol and (meth)acrylate containing hydroxyl group.

Examples of the isocyanate compound include diisocyanates such as hexamethylene diisocyanate, isophorone diisocyanate, bis(4-isocyanatocyclohexyl)methane, bis(4-isocyanatophenyl)methane, bis(3-chloro-4-isocyanatophenyl)methane, 2,4-tolylene diisocyanate, 2,6-tolylene diisocyanate, tris(4-isocyanatophenyl)methane, 1,2-xylylene diisocyanate, 1,4-xylylene diisocyanate, 1,2-hydrogenated xylylene diisocyanate, 1,4-hydrogenated xylylene diisocyanate, tetramethylxylylene diisocyanate, hydrogenated tetramethylxylylene diisocyanate, naphthalene diisocyanate, hexamethylene diisocyanate, norbornane diisocyanate, or dicyclohexylmethane-4,4′-diisocyanate. It may be used either singly or in combination of two or more types.

Among the compounds described above, from the viewpoint of giving resistance to yellowing to a curable composition, a diisocyanate compound having an alicyclic skeleton such as isophorone diisocyanate, bis(4-isocyanatocyclohexyl)methane, 1,2-hydrogenated xylylene diisocyanate, 1,4-hydrogenated xylylene diisocyanate, hydrogenated tetramethylxylylene diisocyanate, norbornane diisocyanate, or dicyclohexylmethane-4,4′-diisocyanate is preferable.

As for the polyhydric alcohol, various commercially available polyhydric alcohols can be used. Examples thereof include polyether polyols such as polyethylene glycol, polypropylene glycol, polytetramethylene glycol, or 1-methylbutylene glycol; polyhydric alcohols such as neopentyl glycol, ethylene glycol, diethylene glycol, propylene glycol, 1,6-hexane diol, 1,4-butane diol, 1,9-nonanediol, 1,10-decane diol, 3-methylpentane diol, 2,4-diethylpentane diol, tricyclodecane dimethanol, 1,4-cyclohexane dimethanol, 1,2-cyclohexane dimethanol, 1,3-cyclohexane dimethanol, cyclohexanediol, hydrogenated bisphenol A, bisphenol A, trimethylol propane, or pentaerythritol; polyether-modified polyols in which alkylene oxide such as ethylene oxide, propylene oxide, or butylene oxide is added to the polyhydric alcohols; polyester polyols obtained by a reaction between the polyhydric alcohols and polybasic acids such as succinic acid, phthalic acid, hexahydrophthalic acid, terephthalic acid, adipic acid, azelaic acid, or tetrahydrophthalic acid, or acid anhydride of the polybasic acid; polycaprolactone polyols obtained by a reaction between the polyhydric alcohols and lactones such as ε-caprolactone, γ-butyrolactone, γ-valerolactone, or δ-valerolactone; caprolactone-modified polyester polyols obtained by a reaction between the polyhydric alcohols, polybasic acids, and lactones such as ε-caprolactone, γ-butyrolactone, γ-valerolactone, or δ-valerolactone; polycarbonate diols obtained by a transesterification reaction between diols such as 1,6-hexane diol, 3-methylpentane diol, 2,4-diethylpentane diol, trimethylhexanediol, 1,4-butane diol, 1,5-pentane diol, or 1,4-cyclohexane diol and carbonate esters such as ethylene carbonate, dimethyl carbonate, diethyl carbonate, di-n-propyl carbonate, diisopropyl carbonate, dibutyl carbonate, dicyclohexyl carbonate, or diphenyl carbonate; polybutadiene glycols; and amide polyols obtained by a reaction between cyclic hydroxycarboxylic acid ester and ammonia or a compound containing one primary or secondary amino nitrogen. It may be used either singly or in combination of two or more types.

Among them, due to excellent surface curing property, polytetramethylene glycol, polycaprolactone polyols, polycarbonate diols, and amide diols are preferable.

As for the (meth)acrylate containing hydroxyl group, it is sufficient to have (meth)acrylate containing a hydroxyl group which contains at least one (meth)acryloyloxy in the molecule and at least one hydroxyl group in the molecule. Specific examples thereof include (meth)acrylates such as 2-hydroxyethyl (meth)acrylate, 2-hydroxypropyl (meth)acrylate, 4-hydroxybutyl (meth)acrylate, 6-hydroxyhexyl (meth)acrylate, cyclohexane dimethanol mono(meth)acrylate, trimethylol propanedi(meth)acrylate, or pentaerythritol tri(meth)acrylate and caproplactone adducts thereof. It may be used either singly or in combination of two or more types.

Among them, from the viewpoint of a possibility of lowering viscosity of a curable composition, 2-hydroxyethyl (meth)acrylate, 2-hydroxypropyl (meth)acrylate, and 4-hydroxybutyl (meth)acrylate are particularly preferable.

As for the synthetic method, a well known method for synthesizing urethane(meth)acrylate can be used. For example, 2 moles of diisocyanate are added to a flask, a known catalyst such as dibutyl tin dilaurate is added at 50 to 300 ppm with reference to the total amount of the diisocyanate, the following diol compound, the following catalyst (if present), and a solvent used for the synthesis, and 1 mole of the diol compound is added dropwise over 2 to 4 hours by using a dropping funnel while the internal temperature of the flask is maintained at 40 to 60° C. to obtain a urethane prepolymer. After that, the isocyanate group present at an end of the obtained urethane prepolymer is subjected to an addition reaction according to dropwise addition of an equivalent amount of (meth)acrylate containing a hydroxy group when the internal temperature of the flask is at 60 to 75° C.

The content of urethane(meth)acrylate is, with reference to 100 parts by mass of the total amount of the component (A) and the component (B), preferably 0 to 50 parts by mass, and more preferably 5 to 40 parts by mass.

When the content of urethane(meth)acrylate is more than 0 part by mass, the surface curability of a curable composition tends to improve. When it is 5 parts by mass or more, a cured coating film having excellent toughness and weather resistance tends to be obtained. On the other hand, when the content is 50 parts by mass or less, liquid viscosity of a curable composition is lowered, and thus the coating workability on a base tends to improve.

The ultraviolet ray curable resin (A) also includes acrylic resin (D) which has a radical polymerizable unsaturated group in a side chain. Examples of the acrylic resin (D) which has a radical polymerizable unsaturated group in a side chain include a polymer having a radical polymerizable unsaturated group therein which has the glass transition temperature of 25 to 170° C., and preferably 30 to 150° C. Specifically, a polymer obtained by polymerization or co-polymerization of any one of the following compounds 1 to 8 to which a radical polymerizable unsaturated group is introduced to a side chain by the method (a) to (d) described below can be used.

1. Monomers having hydroxyl group: N-methylol acrylamide, 2-hydroxyethyl (meth)acrylate, 2-hydroxypropyl (meth)acrylate, 2-hydroxybutyl (meth)acrylate, 2-hydroxy-3-phenoxypropyl (meth)acrylate, or the like

2. Monomers having carboxy group: (meth)acrylic acid, acryloyloxyethylmonosuccinate, or the like

3. Monomers having epoxy group: glycidyl(meth)acrylate, 3,4-epoxycyclohexylmethyl (meth)acrylate, or the like

4. Monomers having aziridinyl group: 2-aziridinyl ethyl (meth)acrylate, allyl 2-aziridinylpropionate, or the like

5. Monomers having amino group: (meth)acrylamide, diacetone acrylamide, dimethylaminoethyl (meth)acrylate, diethylaminoethyl (meth)acrylate, or the like

6. Monomers having sulfone group: 2-acrylamide-2-methylpropane sulfonic acid, or the like

7. Monomers having isocyanate group: an adduct of radical polymerizable monomer having diisocyanate and active hydrogen such as equimolar adduct of 2,4-toluene diisocyanate and 2-hydroxyethylacrylate, 2-isocyanate ethyl (meth)acrylate, or the like

8. Further, it is also possible to perform copolymerization of the above compound with a monomer copolymerizable with it to control the glass transition temperature of the copolymer. Examples of the copolymerizable monomer include (meth)acrylates such as methyl (meth)acrylate, tricyclodecanyl (meth)acrylate, or isobornyl (meth)acrylate, imide derivatives such as N-phenylmaleimide, cyclohexylmaleimide, or N-butylmaleimide, an olefinic monomer such as butadiene, and an aromatic vinyl compound such as styrene or α-methylstyrene.

Next, a radical polymerizable unsaturated group is introduced to the polymer, which is obtained as described above, according to the methods (a) to (d) described below.

(a) In the case of a polymer or a copolymer of a monomer having a hydroxyl group, a monomer having a carboxy group such as (meth)acrylic acid is subjected to a condensation reaction with a side chain, or a monomer having an epoxy group, a monomer having an aziridinyl group, a monomer having an isocyanate group, or an equimolar adduct of a diisocyanate compound and an acrylic acid ester monomer containing a hydroxyl group is subjected to an addition reaction with a side chain.

(b) In the case of a polymer or a copolymer of a monomer having a carboxy group or a sulfone group, the aforementioned monomer having a hydroxyl group is subjected to a condensation reaction with a side chain.

(c) In the case of a polymer or a copolymer of a monomer having an epoxy group, an isocyanate group, or an aziridinyl group, the aforementioned monomer having a hydroxyl group or a monomer having a carboxy group is subjected to an addition reaction with a side chain.

(d) In the case of a polymer or a copolymer of a monomer having a carboxy group, a monomer having an epoxy group, a monomer having an aziridinyl group, a monomer having an isocyanate group, or an equimolar adduct of a diisocyanate compound and an acrylic acid ester monomer containing a hydroxyl group is subjected to an addition reaction with a side chain.

The reaction is preferably performed by adding a trace amount of a polymerization inhibitor such as hydroquinone and flushing with dry air. The amount of radical polymerizable unsaturated group in a side chain of an acrylic resin is, in terms of the equivalent of a double bond (average molecular weight per side chain radical polymerizable unsaturated group) based on the total amount of the polymer in which any one of the compound 1 to 8 is polymerized or co-polymerized and the monomer for introducing a radical polymerizable unsaturated group to the side chain by the aforementioned method (a) to (d), preferably 1 to 1,200 g/mol on average as a calculated value from the viewpoint of improving abrasion resistance. More preferred range of the double bond equivalent is 1 to 600 g/mol on average.

As described above, by introducing to an acrylic resin plural functional groups that are related to cross-linking, it becomes possible to efficiently improve the curing property.

The number average molecular weight of an acrylic resin is preferably in the range of 5,000 to 2,500,000, and more preferably in the range of 10,000 to 1,000,000. From the viewpoint of adhesiveness to a base, the number average molecular weight is preferably 5,000 or more. On the other hand, from the viewpoint of easy synthesis or appearance, the number average molecular weight is 2,500,000 or less.

Further, it is preferable that the glass transition temperature of the acrylic resin is adjusted to 25 to 175° C. It is more preferably adjusted to 30 to 150° C. From the viewpoint of the adhesiveness to a base, the glass transition temperature is preferably 25° C. or higher. Meanwhile, from the viewpoint of easy synthesis or appearance, the glass transition temperature is preferably 175° C. or lower.

Further, considering the glass transition temperature of an acrylic resin copolymer to be obtained, it is preferable to use a vinyl polymerizable monomer which can serve as a homopolymer with a high glass transition temperature. Further, because a vinyl polymerizable monomer having, in the molecule, a group which is capable of reacting with a functional group on a surface of the surface-treated inorganic microparticles (B) that are used as an essential component in the present invention, for example, at least one functional group selected from a group consisting of a hydroxyl group, a carboxy group, a halogenated silyl group, and an alkoxysilyl group, functions to further improve physical properties of a cure coating film to be obtained, for example, toughness, stiffness, and heat resistance, those functional groups can be also contained as a part of the vinyl polymerizable monomer component which is radical polymerizable.

Examples of the vinyl polymerizable monomer containing such reactive group in the molecule include 2-hydroxyethyl (meth)acrylate, 2-hydroxypropyl (meth)acrylate, (meth)acrylic acid, vinyl trichlorosilane, vinyl trimethoxysilane, γ-(meth)acryloyloxypropyl trimethoxysilane, and γ-(meth)acryloyloxypropyl dimethoxymethylsilane.

When the acrylic resin (D) is used, the content of the acrylic resin (D) is, with reference to 100 parts by mass of the total amount of the component (A) and the component (B) of the ultraviolet ray curable resin, preferably 0 to 80 parts by mass, and more preferably 0 to 70 parts by mass.

When the content of the acrylic resin (D) is more than 0 part by mass, the surface curability of the curable composition tends to improve. On the other hand, when the content is 80 parts by mass or less, liquid viscosity of the curable composition is lowered, and thus the coating workability on a base tends to improve.

The component (a) may be used either singly or in combination of two or more types.

The content of the component (a) is, with reference to 100 parts by mass of the total amount of the component (A) and the component (B) of the ultraviolet ray curable resin, preferably 20 to 100 parts by mass, and more preferably 30 to 95 parts by mass. When the content is 30 parts by mass or more, the hardness of the cured coating film to be obtained is excellent. On the other hand, when it is 95 parts by mass or less, the cure shrinkage is reduced, and thus the weather resistance is improved.

<(B) Inorganic Microparticles Having Functional Group Capable of Binding to (A)>

According to the present invention, the cured layer (that is, hard coat layer or cured coating film) is formed by containing the inorganic microparticles (B) having functional group capable of binding to the aforementioned component (A).

By containing the component (B), a cured product to be obtained can be provided with hardness (hereinbelow, described as the component (B)).

The functional group capable of binding to the component (A) indicates a functional group which forms a covalent group with the component (A) based on an addition reaction or a condensation reaction, and examples thereof include a hydroxyl group, an epoxy group, a glycidyl group, an amino group, a mercapto group, a halogen group, an isocyanate group, a methacryloyloxy group, and acryloyloxy group, a vinylphenylene group, and a vinyl group.

The surface modified inorganic microparticles (B) that are used in the present invention indicate a product of condensation reaction between colloidal silica microparticles (b1) (hereinbelow, abbreviated as the “component (b1)”) and a hydrolysis product of an organic silane compound (b2) (hereinbelow, abbreviated as the “component (b2)”) in which the surface of the hydrophilic colloidal silica microparticles are coated with silicone for hydrophobization.

For such reasons, the component (B) can have excellent compatibility with other components, and thus it can provide a cured coating film to be obtained with good transparency. The component (B) can also provide a cured coating film to be obtained with abrasion resistance.

Hereinbelow, descriptions are given regarding the component (b1) and the component (b2) that are used for obtaining the component (B).

The component (b1) can significantly improve the abrasion resistance of a cured coating film, and it particularly has an excellent effect of improving abrasion resistance to microparticles such as silica.

As for the component (b1), colloidal silica microparticles, in which primary particle has area average particle diameter (hereinbelow, abbreviated as “primary particle diameter”) of preferably 1 to 200 nm, and particularly preferably 5 to 80 nm, dispersed in a dispersion medium may be used. However, it is not particularly limited to that particle diameter range.

When the primary particle diameter of the component (b1) is 1 nm or more, the component (B) can have good storage stability. When it is 200 nm or less, the cured coating film can have good transparency.

Examples of the dispersion medium for the component (b1) include water and an organic solvent.

Specific examples of the organic solvent include water; an alcohol solvent such as methanol, ethanol, isopropanol, n-propanol, isobutanol, or n-butanol; a polyhydric alcohol solvent such as ethylene glycol; a polyhydric alcohol derivative such as ethyl cellosolve or butyl cellosolve; a ketone solvent such as methyl ethyl ketone or diaceton alcohol; and a monomer such as 2-hydroxyethylacrylate, 2-hydroxypropylacrylate, or tetrahydrofurfuryl acrylate.

Among them, the alcohol solvent having 3 or less carbon atoms is particularly preferable because it has a simple reaction process with the component (b2).

As for the component (b1), it can be used after being produced by a known method or a commercially available product can be used.

The component (b2) is a component for improving the compatibility with the component (A) as it is hydrolyzed to yield a silanol compound and reacted in advance with the component (b1).

The organosilane compound used for obtaining the component (b2) is not particularly limited, and a known one can be used.

Specific examples of the organosilane compound include methyl trimethoxysilane, dimethyl dimethoxysilane, phenyl trimethoxysilane, diphenyl dimethoxysilane, methyl triethoxysilane, dimethyl diethoxysilane, phenyl triethoxysilane, diphenyl diethoxysilane, vinylphenylene trimethoxysilane, vinylphenylene triethoxysilane, hexyl trimethoxysilane, decyltrimethoxysilane, vinyltris(3-methoxyethoxy)silane, vinyl triethoxysilane, vinyl trimethoxysilane, 3-methacryloyloxypropyl trimethoxysilane, 3-acryloyloxypropyl trimethoxysilane, 3-methacryloyloxypropyl triethoxysilane, β-(3,4-epoxycyclohexyl)ethyl trimethoxysilane, 3-glycidoxypropyl trimethoxysilane, 3-glycidoxypropylmethyl diethoxysilane, 3-methacryloyloxypropylmethyl diethoxysilane, N-β(aminoethyl)γ-aminopropyl trimethoxysilane, N-β(aminoethyl)γ-aminopropylmethyl dimethoxysilane, 3-aminopropyl triethoxysilane, N-phenyl-β-aminopropyl trimethoxysilane, 3-mercaptopropyl trimethoxysilane, 3-chloropropyl trimethoxysilane, 3-isocyanatopropyl triethoxysilane, perfluoroalkyl trimethoxysilane, a Michael adduct between (meth)acrylate having a perfluoroalkyl group and trimethoxysilane containing an amino group, a Michael adduct between (meth)acrylate having a perfluoroalkyl group and trimethoxysilane containing a mercapto group, and an adduct between alcohol having a perfluoroalkyl group and trimethoxysilane containing an isocyanate group.

It may be used either singly or in combination of two or more types.

Further, a silane compound having (meth)acrylic acid added to an epoxy group or a glycidyl group of those compounds, a silane compound obtained by Michael addition of a compound having two (meth)acryloyloxy groups to an amino group, a silane compound obtained by adding a compound having a (meth)acryloyloxy group and an isocyanate group to an amino group or a mercapto group, and a silane compound obtained by adding a compound having a (meth)acryloyloxy group and a hydroxyl group to an isocyanate group can be also used.

From the viewpoint of easily forming a chemical bond with the component (A), vinylphenylene trimethoxysilane, vinylphenylene triethoxysilane, vinyltris(3-methoxyethoxy)silane, vinyl triethoxysilane, vinyl trimethoxysilane, 3-methacryloyloxypropyl trimethoxysilane, 3-acryloyloxypropyl trimethoxysilane, 3-methacryloyloxypropyl triethoxysilane, β-(3,4-epoxycyclohexyl)ethyl trimethoxysilane, 3-glycidoxypropyl trimethoxysilane, 3-glycidoxypropylmethyl diethoxysilane, 3-methacryloyloxypropylmethyl diethoxysilane, N-β(aminoethyl)γ-aminopropyl trimethoxysilane, N-β(aminoethyl)γ-aminopropylmethyl dimethoxysilane, 3-aminopropyl triethoxysilane, N-phenyl-γ-aminopropyl trimethoxysilane, 3-mercaptopropyl trimethoxysilane, 3-chloropropyl trimethoxysilane, and 3-isocyanatopropyl triethoxysilane are preferable.

Among them, the most preferred organosilane compound is a monomer represented by the following general formula (1).

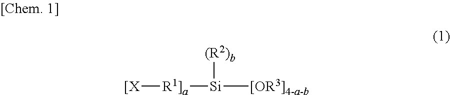

(in the formula, X represents a methacryloyloxy group, an acryloyloxy group, a vinylphenylene group, or a vinyl group, R⁷ represents a linear or branched alkylene group having 0 to 8 carbon atoms, R⁸ and R⁹ represent a linear or branched alkyl group having 1 to 8 carbon atoms, a represents an integer of 1 to 3, b represents an integer of 0 to 2, and a+b represents an integer of 1 to 3).

The monomer represented by the general formula (1) can form a chemical bond with the component (A) and it can be also obtain the photocurable component (B). Further, by using such component (B), toughness can be given to a cured coating film to be obtained.

Examples of the monomer represented by the general formula (1) particularly include a silane compound having an acryloyloxy group, a methacryloyloxy group, a vinylphenylene group, or a vinyl group which exhibits polymerization activity upon irradiation of active energy ray.

Specific examples of the silane compound represented by the general formula (1) include 3-methacryloyloxypropyl trimethoxysilane, 3-acryloyloxypropyl trimethoxysilane, 2-methacryloyloxyethyl trimethoxysilane, 2-acryloyloxyethyl trimethoxysilane, 3-methacryloyloxypropyl triethoxysilane, 3-acryloyloxypropyl triethoxysilane, 2-methacryloyloxyethyl triethoxysilane, 2-acryloyloxyethyl triethoxysilane, 3-methacryloyloxypropylmethyl dimethoxysilane, 3-acryloyloxypropylmethyl dimethoxysilane, vinylphenylene trimethoxysilane, vinylphenylene triethoxysilane, vinyl trimethoxysilane, and vinyl triethoxysilane.

It may be used either singly or in combination of two or more types.

Among them, a silane compound selected from 3-methacryloyloxypropyl trimethoxysilane, 3-acryloyloxypropyl trimethoxysilane, 3-methacryloyloxypropyl triethoxysilane, 3-acryloyloxypropyl triethoxysilane, vinyl trimethoxysilane, and vinyl triethoxysilane is particularly preferable in that they have excellent reactivity with the component (A).

The method for producing the component (B) used for the present invention is not particularly limited. However, it can be obtained by, for example, performing azeotropic distillation extraction of a dispersion medium for the component (b1) with a nonpolar solvent such as toluene under normal or reduced pressure in the presence of a dispersion of the component (b1) and the component (b2) for substituting the dispersion medium with a nonpolar solvent, and reacting them under heating.

Meanwhile, when the dispersion medium for the component (b1) is already substituted with a nonpolar solvent, it is sufficient that water produced by the condensation reaction is discharged from the system based on azeotrope.

Hereinbelow, the method for producing the component (B) is described in detail with reference to specific examples.

The expression “in the presence of the component (b1) and the component (b2)” described herein indicates a state which is obtained by the following two methods.

Method 1: According to a common method which includes mixing the component (b1) with an organosilane compound, adding a catalyst for hydrolysis, and stirring at normal temperature or under heating, the component (b1) and the component (b2) are allowed to co-exist.

Method 2: The component (b2) which is obtained by previous hydrolysis of an organosilane compound is mixed with the component (b1) so that they are allowed to co-exist.

Specifically, in the presence or absence of an organic solvent such as an alcohol solvent, by adding a catalyst for hydrolysis such as 0.5 to 6 mol water or 0.001 to 0.1 N aqueous solution of hydrochloric acid or acetic acid to 1 mol organosilane compound, in the presence of the component (b1) for Method 1 or in the absence of the component (b1) for the Method 2, and discharging the alcohol produced by hydrolysis from the system under stirring and heating, the hydrolysis product can be produced.

Subsequently, the condensation reaction can be carried out in the following order.

Specifically, in the presence of the component (b2) for Method 1 or after mixing the component (b2) and the component (b1) for Method 2, water produced by a condensation reaction with dispersion medium in the component (b1) is subjected to azeotropic distillation extraction under normal or reduced pressure at a temperature of 60 to 100° C., and preferably 70 to 90° C. to adjust the solid matter concentration to 50 to 90% by mass.

Next, a nonpolar solvent such as toluene is added to the system and the condensation reaction is performed by stirring for 0.5 to 10 hours while performing again the azeotropic distillation extraction of the nonpolar solvent, water, and the dispersion medium for colloidal silica microparticles and maintaining the solid matter concentration at 30 to 90% by mass, and preferably 50 to 80% by mass at a temperature of 60 to 150° C., and preferably 80 to 130° C.

At that time, for the purpose of promoting the reaction, a catalyst such as water, an acid, a base, or a salt may be used.

The component (B) can be obtained accordingly.

Specific examples of the nonpolar solvent include hydrocarbons such as benzene, toluene, xylene, ethylbenzene, or cyclohexane; halogenated hydrocarbons such as trichloroethylene or tetrachloroethylene; ethers such as 1,4-dioxane or dibutyl ether; and esters such as n-butyl acetate, isobutyl acetate, ethyl acetate, or ethyl propionate.

Among those nonpolar solvents, the hydrocarbons and the aromatic hydrocarbons are preferred from the viewpoint of the reaction between the component (b1) and the component (b2). Particularly preferred examples of the nonpolar solvent include toluene and xylene. After the condensation reaction between the component (b1) and the component (b2), those nonpolar solvents can be suitably substituted with a solvent desired for use, depending on the base for an application.

During the process for producing the component (B) described above, the content (hereinbelow, abbreviated as the “solid matter concentration”) of the component (b1) is preferably in the range of 30 to 90% by mass.

When the solid matter concentration is 30% by mass or more, a good reaction between the component (b1) and the component (b2) is obtained, and the cured coating film which is obtained by using a curable composition using them can have sufficient transparency.

Further, when the solid matter concentration is 90% by mass or less, the condensation reaction does not occur vigorously so that the coating workability of the curable composition and the physical properties of a cured coating film to be obtained are good.

The temperature during the condensation reaction for obtaining the component (B) is preferably in the range of 60 to 150° C. When the reaction temperature is 60° C. or higher, the reaction progresses sufficiently so that the reaction time tends to be shorter. On the other hand, when the reaction temperature is 150° C. or lower, it is unlikely to have a reaction other than the condensation of silanol or gellation.

With regard to the production of the component (B), the use ratio between the component (b1) and the component (b2) during the reaction process is, in terms of mass ratio, (b1)/(b2)=40 to 90/10 to 60, and preferably 50 to 80/20 to 50 (with the proviso that, the total amount of the component (b1) and the component (b2) is 100 parts by mass).

When the use ratio of the component (b1) is 40 parts by mass or more, there is a tendency that the reactivity is good and the abrasion resistance of a cured coating film using it is improved. On the other hand, when it is 90 parts by mass or less, whitening or gellation of the reaction system does not occur so that it is difficult for a cured coating film using it to have an occurrence of cracks.

Further, according to the reaction between the component (b1) and the component (b2) in a nonpolar solvent, the component (B) having good compatibility with the component (A) can be synthesized.

In the present invention, the content of the component (B) is not particularly limited. However, in 100 parts by mass of the total of the component (B) and the component (A), it is preferably 5 to 60 parts by mass, and more preferably 15 to 40 parts by mass.

When the content of the component (B) is 5 parts by mass or more, the hardness of a cured coating film to be obtained is sufficiently expressed. On the other hand, when it is 60 parts by mass or less, there is a tendency that the cured coating film to be obtained is unlikely to have an occurrence of cracks.

The curable composition according to an embodiment of the present invention may contain (C) in addition to the aforementioned (A) and (B).

With regard to (C), an active energy ray sensitive radical polymerization initiator generates radicals in response to active energy ray represented by ultraviolet ray or visible ray, and conventionally known various types can be used (hereinbelow, described as the component (C)).

Specific examples of the active energy ray sensitive radical polymerization initiator include benzoin, benzoin monoethyl ether, acetoin, benzyl, benzophenone, p-methoxybenzophenone, diethoxyacetophenone, 2,2-dimethoxy-1,2-diphenylethan-1,1-one, 2,2-diethoxyacetophenone, 1-hydroxycyclohexylphenyl ketone, methylphenylglyoxylate, 2-hydroxy-2-methyl-1-phenylpropan-1-one, 2-methyl-1-[4-(methylthio)phenyl]-2-monopolynopropane-1, benzyl dimethyl ketal, tetramethylthiuram monosulfide, tetramethylthiuram disulfide, 2,4,6-trimethylbenzoyl diphenylphosphine oxide, camphor quinone, and bis(cyclopentadienyl)-bis(2,6-difluoro-3-pyrrolyl-1-phenyl)titanium.

Among them, benzophenone, methylphenylglyoxylate, 2-hydroxy-2-methyl-1-phenylpropan-1-one, 1-hydroxycyclohexylphenyl ketone, 2,2-dimethoxy-1,2-diphenylethan-1,1-one, benzyl dimethyl ketal, and 2,4,6-trimethylbenzoyl diphenylphosphine oxide are particularly preferable.

The active energy ray sensitive radical polymerization initiator may be used either singly or in combination of two or more types.

The mixing amount of an active energy ray sensitive radical polymerization initiator is, in 100 parts by mass of the total of the component (A) and the component (B), preferably 0.01 to 10 parts by mass. When the mixing amount is 0.01 part by mass or more, good curability is obtained. On the other hand, when it is 10 parts by mass or less, there is a tendency that a coating film with low coloration is obtained.

The curable composition of the present invention contains a curing catalyst and a solvent. Further, it may also contain inorganic microparticles, a polymer, polymer microparticles, a filler, a dye, a pigment, a pigment dispersant, a fluidity controlling agent, a leveling agent, an anti-foaming agent, a ultraviolet absorbing agent, a photostabilizing agent, an anti-oxidizing agent, gel particles, microparticle powder, or the like, if necessary.

By adding an ultraviolet absorbing agent to the curable composition, the base can be protected against deterioration caused by ultraviolet ray. In particular, when a base made of poor weather resistance (for examples, polycarbonate) is used, it is preferable to add an ultraviolet absorbing agent to the curable composition. For example, any ultraviolet absorbing agent of benzophenone-based, benzotriazole-based, inorganic-based, or polymer-based having ultraviolet absorbing functional group introduced to a polymer chain can be used. Specific examples of the ultraviolet absorbing agent include 2-hydroxybenzophenone, 5-chloro-2-hydroxybenzophenone, 2,4-dihydroxybenzophenone, 2-hydroxy-4-methoxybenzophenone, 2-hydroxy-4-octyloxybenzophenone, 4-dodecyloxy-2-hydroxybenzophenone, 2-hydroxy-4-octadecyloxybenzophenone, 2,2′-dihydroxy-4-methoxybenzophenone, 2,2′-dihydroxy-4,4′-dimethoxybenzophenone, 2-(2-hydroxy-5′-methylphenyl)benzotriazole, 2-(2-hydroxy-5-tert-butylphenyl)-5-chlorobenzotriazole, 2-(2-hydroxy-3,5′-di-tert-butylphenyl)benzotriazole, 2-(2-hydroxy-5-tert-butylphenyl)benzotriazole, 2-(2-hydroxy-4-octyloxyphenyl)benzotriazole, titanium oxide, zinc oxide, an acrylic resin-based ultraviolet absorbing agent having a benzotriazole skeleton or a benzophenone skeleton in the structure, and an acrylic urethane resin-based polymer ultraviolet absorbing agent. Meanwhile, the polymer ultraviolet absorbing agent preferably has molecular weight of 3,000 to 3,000,000. In particular, from the viewpoint of having good compatibility with polyfunctional (meth)acrylate, 2-hydroxy-4-octyloxybenzophenone, 2,4-dihydroxybenzophenone, and 2-(2-hydroxy-5-tert-butylphenyl)benzotriazole are preferable. From the viewpoint of having good water resistance, an acrylic resin-based polymer ultraviolet absorbing agent is preferable (PUVA-M series manufactured by Otsuka Chemical Co., Ltd., RSA series manufactured by Sannan Chemical Industry Co., Ltd., USL series manufactured by Ipposha Oil Industries, Co., Ltd., or the like). The ultraviolet absorbing agent may be used either singly or in combination of two or more types.

The addition amount of the ultraviolet absorbing agent is, in 100 parts by mass of the total of the component (A) and the component (B), preferably 0.1 to 20 parts by mass, and more preferably 0.1 to 15 parts by mass. When the mixing amount is 0.1 part by mass or more, deterioration of a base caused by ultraviolet ray can be suppressed. On the other hand, when it is 20 parts by mass or less, a decrease in the abrasion resistance of a cured coating film can be suppressed.

Further, a hindered amine type photostabilizing agent can be added, if necessary. Specific examples thereof include bis(2,2,6,6-tetramethyl-4-piperidyl)sebacate, bis(1,2,2,6,6-pentamethyl-4-piperidyl)sebacate, bis(1-methoxy-2,2,6,6-tetramethyl-4-piperidyl)sebacate, bis(1-ethoxy-2,2,6,6-tetramethyl-4-piperidyl)sebacate, bis(1-propoxy-2,2,6,6-tetramethyl-4-piperidyl)sebacate, bis(1-butoxy-2,2,6,6-tetramethyl-4-piperidyl)sebacate, bis(1-pentyloxy-2,2,6,6-tetramethyl-4-piperidyl)sebacate, bis(1-hexyloxy-2,2,6,6-tetramethyl-4-piperidyl)sebacate, bis(1-heptyloxy-2,2,6,6-tetramethyl-4-piperidyl)sebacate, bis(1-octoxy-2,2,6,6-tetramethyl-4-piperidyl)sebacate, bis(1-nonyloxy-2,2,6,6-tetramethyl-4-piperidyl)sebacate, bis(1-decanyloxy-2,2,6,6-tetramethyl-4-piperidyl)sebacate, bis(1-dodecyloxy-2,2,6,6-tetramethyl-4-piperidyl)sebacate, bis(1,2,2,6,6-pentamethyl-4-piperidyl)-2-(4-methoxy-benzylidene)malonate, tetrakis(2,2,6,6-pentamethyl-4-piperidyl)1,2,3,4-butane tetracarboxylate, tetrakis(1,2,2,6,6-pentamethyl-4-piperidyl)1,2,3,4-butane tetracarboxylate, a condensate of 1,2,3,4-butane tetracarboxylic acid, 1,2,2,6,6-pentamethyl-4-piperidinol, and β,β,β,β-tetramethyl-3,9-(2,4,8,10-tetraoxaspiro[5,5])undecane)diethanol, a condensate of 1,2,3,4-butane tetracarboxylic acid, 2,2,6,6-pentamethyl-4-piperidinol, and β,β,β,β-tetramethyl-3,9-(2,4,8,10-tetraoxaspiro[5,5])undecane) diethanol, and a reaction product between a diester compound of decane dicarboxylic acid and 2,2,6,6-tetramethyl-1-octoxy-4-piperidinol, 1,1-dimethylethylhydroperoixde, and octane (“TINUVIN 123” manufactured by BASF Japan Co., Ltd.). Among them, bis(1,2,2,6,6-pentamethyl-4-piperidyl)sebacate and a reaction product between a diester compound of decane dicarboxylic acid and 2,2,6,6-tetramethyl-1-octoxy-4-piperidinol, 1,1-dimethylethylhydroperoixde, and octane are particularly preferable.

The addition amount of the photostabilizing agent is, in 100 parts by mass of the total of the component (A) and the component (B), preferably 0.1 to 8 parts by mass, and more preferably 0.1 to 5 parts by mass. When the mixing amount is 0.1 part by mass or more, deterioration of a cured coating film relating to weather resistance can be suppressed. On the other hand, when it is 8 parts by mass or less, a decrease in the abrasion resistance of a cured coating film can be suppressed.

<Evaluation of Laminate>

According to the laminate of the present invention, the absorbance ratio P_{C═O}/P_{Si—O} of the peak absorbance P_{C═O} around a wavelength of 1730 cm⁻¹ to the peak absorbance P_{Si—O} around a wavelength of 1100 cm⁻¹ falls within the range from 0.15 to 0.35 as measured by a single reflection ATR method using an infrared spectrophotometer.

In the present invention, the peak absorbance around a wavelength indicates absorbance at peak top of a peak including that wavelength. When the value of P_{C═O}/P_{Si—O} is lower than 0.15, the resin component on a laminate surface is decreased so that the binding to inorganic microparticles is weak. As a result, there is a tendency that the abrasion resistance is poor. On the other hand, when the value of P_{C═O}/P_{Si—O} is higher than 0.35, the resin component on a laminate surface is increased so that the abrasion resistance of inorganic microparticles is not sufficiently expressed. As a result, there is a tendency that the abrasion resistance is poor.

By having the above characteristics, the laminate of the present invention has excellent abrasion resistance. In the present invention, a change in haze value ΔH before and after the Taber abrasion test prescribed by ISO 9352 (JIS K-7204) (test condition: abrasion wheel of CS-10F, load of 500 g, and 500 revolutions) is used as an indicator of the abrasion resistance. The laminate of the present invention has a change in haze value ΔH of 11% or less, preferably 8% or less, and more preferably 6% or less.

<Method for Producing Laminate>

The laminate of the present invention can be formed by forming on a base a coating film of a curable composition containing (A) a heat- and/or ultraviolet ray-curable resin and (B) inorganic microparticles having a functional group capable of binding to the component (A) and curing the coating film with heat and/or ultraviolet ray.

For forming a coating film on a base, a roll coating method, a gravure coating method, a flexography method, a screening, a flow coating method, a spray coating method, an impregnation method, or the like can be used.

When coating is formed with the curable composition of the present invention, thickness of the coated film can be 0.1 to 100 μm, for example.

The shape, material, or thickness of the base is not particularly limited in the present invention. Instead, various ones that have been conventionally known to be used for a molded article made of a resin can be used. Specific examples thereof include a polymethylmethacryl resin, a polycarbonate resin, a polyester resin, a poly(polyester) carbonate resin, a polystyrene resin, an ABS resin, an AS resin, a polyamide resin, a polyarylate resin, a polymethacrylimide resin, a polyallyl diglycol carbonate resin, a polyolefin resin, and an amorphous polyolefin resin. Particularly, a polymethylmethacryl resin, a polycarbonate resin, a polystyrene resin, a polymethacrylimide resin, and an amorphous polyolefin resin have excellent transparency and are strongly required to have improved abrasion resistance, and thus they are particularly effective for an application of the curable composition of the present invention.

Further, the cured coating film of the present invention can be also applied to a base such as metal, can, paper, wooden material, and inorganic material as well as a resin base.

Next, the present invention is explained in detail in view of the examples. However, the present invention is not limited to the examples.

### EXAMPLES

### Synthetic Example 1 (UA-1)

To a flask equipped with a dropping funnel with an incubation function, a reflux condenser, a stirring wing, and a temperature sensor, 2 mol of dicyclohexylmethane-4,4′-diisocyanate and 300 ppm of n-butyl tin dilaurate were added and heated to 40° C. While the dropping funnel with an incubation function is heated to 40° C., 1 mol of polycarbonate diol having a 3-methylpentane structure (number average molecular weight of 800, trade name of “KURARAY Polyol C770” manufactured by Kuraray Co., Ltd.) was added dropwise thereto over 4 hours. After stirring for 2 hours at 40° C., the temperature was increased again to 70° C. over 1 hour. After that, 2 mol of 2-hydroxyethylacrylate was added dropwise thereto over 2 hours. By stirring again for 2 hours, the component (UA-1) was synthesized.

### Synthetic Example 2 (D)

To a 1 liter four-neck flask equipped with an inlet for nitrogen, a stirrer, a condenser, and a thermometer, 50.0 g of methyl ethyl ketone were added and the temperature was increased to 80° C. Under nitrogen atmosphere, a mixture of 67.8 g of methyl methacrylate, 32.2 g of glycidyl methacrylate, and 0.5 g of azobis isobutyronitrile was added dropwise thereto over 3 hours. After that, a mixture of 80.0 g of methyl ethyl ketone and 0.2 g of azobis isobutyronitrile was added and polymerized. After 4 hours, 50.0 g of methyl ethyl ketone, 0.5 g of hydroquinone monomethyl ether, 2.5 g of triphenyl phosphine, and 16.3 g of acrylic acid were added and stirred for 30 hours at 80° C. with air flushing. Then, after cooling, the reactant was removed from the flask to obtain a solution of an acrylic resin having a radical polymerizable unsaturated group in a side chain.

The monomer polymerization rate of the acrylic resin was 99.5% or more, the polymer solid matter amount was about 40% by mass, the number average molecular weight was about 60,000 (GPC measurement, in terms of polystyrene as a reference), and the glass transition temperature was about 77° C. (measured by DSC based on JIS-K7121).

### Synthetic Example 3

### Synthesis of Surface Modified Inorganic Microparticles (B−1)

To a 3 liter four-neck flask equipped with a stirrer, a thermometer, and a condenser, 1200.0 g of methanol silica sol (360.0 g as SiO₂ powder) (dispersion medium; methanol, SiO₂ concentration; 30% by mass, primary particle diameter; 12 nm, trade name “MT-ST” manufactured by Nissan Chemical Industries, Ltd.) (hereinbelow, abbreviated as “MT-ST”) and 230.0 g of 3-methacryloyloxypropyl trimethoxysilane (trade name “SZ6030” manufactured by Toray•Dow Corning Co., Ltd.) as an organosilane compound were added. The temperature was increased under stirring. 100.0 g of pure water was slowly added dropwise thereto simultaneously with starting the reflux of volatile components. When the dropwise addition is completed, stirring was performed for 2 hours under reflux to perform hydrolysis.

When the hydrolysis is completed, volatile components such as alcohol and water were distilled and extracted under atmospheric pressure. At a time point at which the solid matter concentration is 60% by mass, 720.0 g of toluene were added and azeotropic distillation of alcohol, water, or the like with toluene was performed

Next, toluene was added in an amount of 1,000.0 g and complete solvent substitution was performed to give a toluene dispersion system. The solid matter concentration was about 40% by mass at that time.

Further, the reaction was allowed to occur for 4 hours at 110° C. while performing distillation extraction of toluene so as to obtain the solid matter concentration of about 60% by mass. After that, 1,000.0 g of 1-methoxy-2-propanol was added again and the toluene was evaporated and extracted by distillation for performing solvent substitution. As a result, 1-methoxy-2-propanol dispersion system was obtained. The obtained organic-coated silica dispersion was a yellow and transparent liquid, and the solid matter concentration was 50% by mass in terms of residuals after heating.

### Example 1

A curable composition was prepared with the mass addition ratio shown in Table 1, and applied to a polycarbonate resin board (trade name “LEXAN LS-2”, manufactured by Sabic Innovative Plastics) with thickness of 3 mm by bar coating such that the coating film is 8 μm after curing. Subsequently, the organic solvent components were evaporated by performing a heating treatment for 3 minutes in an oven at 80° C. After that, by using a high pressure mercury lamp, energy ray with accumulated light amount of 3,000 mJ/cm² for a wavelength of 340 nm to 380 nm was radiated in an air to obtain a cured layer (that is, cured coating film). Subsequently, by using a xenon excimer lamp which radiates vacuum ultraviolet ray with wavelength of 172 nm (manufactured by M. D. Excimer, Inc., irradiation strength: 50 mW/cm), irradiation was made twenty times under nitrogen atmosphere while having the polycarbonate resin board with a cured film 14 mm apart from the lamp surface. As a result, a laminate was obtained. The evaluation results are shown in Table 1.

TABLE 1

| | | Example | | | | Comparative Example | | | |
|---|---|---|---|---|---|---|---|---|---|
| | | 1 | 2 | 3 | 4 | 1 | 2 | 3 | 4 |
| (A) | DCPA20 | 25 | 25 | — | — | 25 | 25 | 25 | — |
| | UA-1 | 25 | 25 | — | — | 25 | 25 | 25 | — |
| | TAIC | 30 | 30 | — | — | 30 | 30 | 30 | — |
| | (D) (NV = 40%) | — | — | 150 (60) | 112.5 (45) | — | — | — | 150 (60) |
| (B) | (B-1) (NV = 50%) | 40 (20) | 40 (20) | 80 (40) | 110 (55) | 40 (20) | — | 40 (20) | 80 (40) |
| (C) | BP | 1 | 1 | — | — | 1 | 1 | 1 | — |
| | MPG | 1 | 1 | — | — | 1 | 1 | 1 | — |
| | TPO | 1 | 1 | — | — | 1 | 1 | 1 | — |
| | HCPK | — | — | 2 | 2 | — | — | — | 2 |
| Solvent | Normal butyl acetate | 15 | 15 | — | — | 15 | 15 | 15 | — |
| | ECA | 10 | 10 | — | — | 10 | 10 | 10 | — |
| | MEK | — | — | 270 | 270 | — | — | — | 270 |
| Others | HBPB(UVA) | 10 | 10 | — | — | 10 | 10 | 10 | — |
| | BPPS(HALS) | 0.5 | 0.5 | — | — | 0.5 | 0.5 | 0.5 | — |
| | IPA-ST(Inorganic | — | — | — | — | — | 66.7 | — | — |
| | microparticles) | | | | | | | | |
| Base | | PC | PC | PMMA | PMMA | PC | PC | PC | PMMA |
| | | (3 mm) | (3 mm) | (100 μm) | (100 μm) | (3 mm) | (3 mm) | (3 mm) | (100 μm) |
| Condition for irradiation of | | 20 times of | 5 times of | 20 times of | 20 times of | No | 20 times of | Low pressure | No |
| vacuum ultraviolet ray | | excimer light | excimer light | excimer light | excimer light | | excimer light | mercury lamp | |
| | | | | | | | | 3 minutes | |
| Absorbance ratio P_{C═O}/P_{Si—O} | | 0.21 | 0.28 | 0.18 | 0.16 | 0.39 | — | 0.38 | 0.36 |
| Appearance | | ◯ | ◯ | ◯ | ◯ | ◯ | X | ◯ | ◯ |
| Film thickness (μm) | | 8.0 | 8.0 | 8.5 | 8.5 | 8.0 | 7.5 | 8.0 | 8.5 |
| Adhesiveness | | ◯ | ◯ | ◯ | ◯ | ◯ | | ◯ | ◯ |
| Abrasion | Change in | 5.0 | 7.0 | 9.2 | 8.3 | 20.2 | 35.2 | 22.5 | 18.7 |
| resistance | haze value ΔH | ◯ | ◯ | ◯ | ◯ | X | X | X | X |

Unit (g) Solid matter amount in parenthesis

[Evaluation of Laminate]

The laminate obtained as described above was evaluated according to the following method. The results are shown in Table 1.

1) Appearance

Transparency and absence or presence of whitening of the test specimen were observed with a naked eye and evaluated according to the following criteria.

O: transparent, and no problem of whitening (good).

X: there is a non-transparent portion and a problem such as whitening and wrinkles (not good).

2) Film thickness

Measurement was made by using MODEL 2010 PRISM COUPLER manufactured by Metricon.

3) Adhesiveness

On a surface of the laminate, eleven dents were created in longitudinal and lateral directions at an interval of 1 mm by using a razor blade. As a result, 100 squares were formed. After close adhesion with Cellophane (registered trademark) tape, abrupt peeling was made in front direction at 45 degrees. Then, the number of squares having an intact laminate surface with no peeling was counted and the evaluation was made based on the following criteria.

O: There was no square with peeling (good adhesiveness).

Δ: There were 1 to 5 squares with peeling (medium adhesiveness).

X: There were at least 6 squares with peeling (poor adhesiveness).

4) Taber abrasion test

ΔH was measured after 500 revolution abrasions using a Taber abrasion tester (trade name: Rotary Abrasion tester, manufactured by Toyo Seiki Co., Ltd.). Abrasion wheel (trade name: CS10F (type IV), revolution speed: 70 rpm, load: 4.9 N (500 gf), and height of suction part: 3 mm).

O: 10 or less

X: more than 10

5) Absorption ratio

The measurement was performed by a single reflection ATR method using an infrared spectrophotometer (FT-IR AVATAR360, manufactured by Nicolet), and the absorbance ratio P_{C═O}/P_{Si—O} of the peak absorbance P_{C═O} around a wavelength of 1,730 cm⁻¹ to the peak absorbance P_{Si—O} around a wavelength of 1,100 cm⁻¹ was obtained.

### Example 2

The laminate was obtained in the same manner as Example 1 except that the condition for vacuum ultraviolet ray irradiation is changed to 5 times of excimer light.

### Example 3

The laminate was obtained in the same manner as Example 1 except that a PMMA film (thickness of 100 μm) is used as a base.

### Example 4

The laminate was obtained in the same manner as Example 2 except that those described in Table 1 are used.

### Comparative Example 1

The laminate was obtained in the same manner as Example 1 except that no excimer irradiation is performed for a surface of the cured layer.

### Comparative Example 2

The laminate was obtained in the same manner as Example 1 except that those described in Table 1 are used.

### Comparative Example 3

The laminate was obtained in the same manner as Example 1 except that irradiation with a low pressure mercury lamp is made for a surface of the cured layer (distance to lamp: 20 mm and irradiation time: 3 minutes).

### Comparative Example 4

The laminate was obtained in the same manner as Example 1 except that no excimer irradiation is performed for a surface of the cured layer.

The abbreviations in Table 1 are as described below.

DPCA20: dipentaerythritol hexaacrylate modified by two caprolactones per molecule (trade name of “KAYARAD DPCA-20”, manufactured by Nippon Kayaku Co., Ltd.)

UA-1: urethane acrylate synthesized from 2 mol of dicyclohexylmethane-4,4′-diisocyanate, 1 mol of polycarbonate diol having a 3-methylpentane structure (number average molecular weight of 800, trade name of “KURARAY Polyol C770” manufactured by Kuraray Co., Ltd.), and 2 mol of 2-hydroxyethylacrylate

TAIC: tris(2-acryloyloxyethyl)isocyanurate

(D): Reactive acrylic polymer

BP: benzophenone

MPG: methylphenyl glyoxylate

TPO: 2,4,6-trimethylbenzoyl diphenylphosphine oxide

HCPK: 1-hydroxycyclohexyl-phenyl ketone

ECA: ethylcarbitol acetate

MEK: methyl ethyl ketone

HBPB: 2-(2-hydroxy-5-tert-butylphenyl)benzotriazole

BPPS: bis(2,2,6,6-tetramethyl-4-piperidyl)sebacate

IPA-ST: colloidal silica dispersed in IPA (solid matter of 30%)

PC: polycarbonate resin with thickness of 3 mm (trade name of “LEXAN LS-2”, manufactured by Sabic Innovative Plastics)

The laminate having the vacuum ultraviolet ray irradiation performed on a surface of a cured layer containing the components (A) and (B) as described above (that is, Examples 1 to 5) was shown to exhibit good results in terms of appearance, adhesiveness, and abrasion resistance.

On the other hand, the laminate in which no vacuum ultraviolet ray irradiation is performed on a surface of a cured layer (that is, Comparative Example 1 and Comparative Examples 3 and 4) or the laminate in which vacuum ultraviolet ray irradiation is performed on a surface of a cured layer which has been formed by containing, instead of the component (B), microparticles not having a functional group capable of binding to the component (A) (that is, Comparative Example 2), does not exhibit good results in any terms of appearance, adhesiveness, and abrasion resistance.

1. A laminate comprising a cured layer formed on a base and made from a curable composition containing (A) a heat- and/or ultraviolet ray-curable resin and (B) inorganic microparticles having a functional group capable of binding to the component (A),
wherein the absorbance ratio P_{C═O}/P_{Si—O} of the peak absorbance P_{C═O} around a wavelength of 1,730 cm⁻¹ to the peak absorbance P_{Si—O} around a wavelength of 1,100 cm⁻¹ falls within the range from 0.15 to 0.35 as measured by a single reflection ATR method using an infrared spectrophotometer.

2. The laminate according to claim 1, wherein the content of the component (B) is 15 to 40 parts by mass in 100 parts by mass of total of the component (A) and the component (B).

3. The laminate according to claim 1, wherein a change in haze value ΔH before and after the Taber abrasion test prescribed by ISO 9352 (JIS K-7204) (test condition: abrasion wheel of CS-10F, load of 500 g, and 500 revolutions) is 10% or less.

4. A method for producing a laminate including:
a step of forming a cured layer by forming on a base a coating film of a curable composition containing (A) a heat- and/or ultraviolet ray-curable resin and (B) inorganic microparticles having a functional group capable of binding to the component (A) and curing the coating film by using heat and/or ultraviolet ray, and
a step of irradiating vacuum ultraviolet ray on a surface of the cured layer.

5. The production method according to claim 4, wherein the irradiation of vacuum ultraviolet ray is performed by using an excimer lamp.
